(19) United States
(12) Patent Application Publication
(10) Pub. No.: US 2007/0062080 A1
(43) Pub. Date: Mar. 22, 2007

(54) Mailable picture frame greeting card

(75) Inventor: Everett K. Bramhall, Concord, MA (US)

Correspondence Address: Robert K. Tendler, 65 Atlantic Avenue, Boston, MA, 02110, US

(73) Assignee: SWING LTD

(21) Appl. No.: 11/228,724

(22) Filed: Sep. 16, 2005

(51) Int. Cl. G09F 1/00

(52) U.S. Cl. 40/124.06

(57) ABSTRACT

A mailable picture frame greeting card includes a folded easel having an apertured front face and an artwork-receiving compartment behind the apertured front face through which a picture or other artwork may be displayed. The card is constructed using a sheet folded to provide a back flap hingedly attached to a front flap and with an easel-maintaining tether, in one embodiment in the form of a tabbed detent ribbon. The untabbed end of the ribbon is fixedly attached to the front flap and the back flap provided with a notch to receive the tabbed end portion of the ribbon, such that the ribbon prevents the two flaps from spreading apart. In one instance the notch has a protective semicircle at the edge of the back flap and a circular hole at the other end. Moreover, a looped and heat-sealed distal ribbon end provides a convenient detent. In one embodiment construction is simplified by providing relatively thick double foam core sticky-backed tape between the front flap and an overlying apertured faceplate or panel, with the thickness of the double sticky-backed tape permitting insertion of a transparent pouch containing a picture or other artwork in the space between the front flap and the panel. Ornamental indicia surrounding the apertured faceplate may be in the form of an apertured frame-shaped panel at the time of manufacture.

### FIELD OF THE INVENTION

This invention relates to greeting cards and more particularly to a mailable picture frame greeting card.

### BACKGROUND OF THE INVENTION

As is quite common, greeting cards have been created in a variety of forms to be slipped into an envelope and mailed to the recipient of the card. In general, these cards can have numerous folds and have windows through which are exposed other portions of the card.

However, in order to personalize greeting cards, it is often desired to provide a picture, which is usually affixed by tape or other adhesive means to one side or the other of the card, whereby the particularized and personalized photograph is presented to the person who opens up the envelope and withdraws the card.

Such presentations, however, do not readily lend themselves to permanent viewing and often become discarded, either because of the flimsy construction, or because they are not of the visual quality that one would like to keep around and have on display.

While it is possible to take conventional picture frames, package them up and send them to an individual to provide them with a favorite picture or the like, these frame structures are heavy in construction, require oversized packing materials, and are not generally shippable without damage in the mail or by express mail services. Importantly, these frames are relatively heavy and require a considerable amount of postage, making such a greeting a one-off item not suitable, for instance, for the type of mailings that one usually does, for instance, at holiday time when numbers of cards are sent to friends and loved ones.

There is therefore a requirement for a greeting card that can carry a picture that will not only be pleasant to see and offer high enough quality so that one might want to display the card year round, but also be of sufficiently rugged construction so as not to be damaged during transit, while at the same time fitting into a standard mailable envelope and being of sufficiently light weight that extra postage is not needed in order to send the greeting card with the picture attached.

Moreover, there is a requirement that once the card is received, there is a convenient mounting method for permanently displaying the card such that it can be placed on a horizontal surface, be it a table, mantle or the like, and stay in position uncurled and in its original orientation so that it may be viewed at all times during the year.

### SUMMARY OF INVENTION

Rather than providing a greeting card with a picture pasted on it, in the subject invention a mailable picture frame greeting card is comprised of a sheet folded at the top and having a back flap and a front flap. The front flap in one embodiment carries an overlying panel that is apertured at its center to permit viewing of a picture or indicia through the aperture.

In one embodiment pictures are located in a transparent envelope or pouch such that the picture can be seen from the outside of the envelope. The envelope is inserted into a slot behind the apertured panel, which is comprised of a back that is the front face of the front flap of the card, and the edges of the apertured panel. In between the apertured panel and the flap is a U-shaped ring of double sticky-backed foam tape that spaces the front panel from the flap, with the tape being U-shaped across the top, down one side and across the bottom. This leaves an opening to one side of the card into which the transparent envelope, which may be acetate or other like plastic material, can be inserted. The spacing between the front apertured panel and the front flap is provided by the thickness of the double sticky-backed tape such that the mailable picture frame greeting card can be easily and inexpensively constructed.

As part of the subject invention, the front flap is provided with a ribbon that has a detent at one end, with the undetented end affixed to the front flap and with the rear flap having a notch in its lower edge adapted to receive the ribbon therethrough. In operation, the detent co-acts with the back of the back flap so that the tentlike structure or easel is constrained from opening any further than the detent ribbon will allow.

This means that the card can be provided with a picture or other artwork in the transparent envelope and sealed into the shipping envelope, with the ribbon lying loose within the shipping envelope, albeit with one end tethered to the front flap of the card.

In a further embodiment, the notch in the lower edge of the back flap that receives the detent ribbon has a semicircular lower aperture at one end of the slot that makes inserting the ribbon easy and prevents the lower flap edge from fraying, especially as it is usually made of card stock or paper.

Secondly, the upper end of the slot is provided with a hole to provide a positive stop for the ribbon. It also prevents slit tearing.

As to one embodiment, to manufacture the detent ribbon, a ribbon butterfly is formed by looping the distal end of a ribbon on itself and heat-sealing the ribbon to itself to provide a laterally extending detent portion. In order to do this, an intermediate portion of the detent ribbon is folded at right angles to the longitudinal axis of the ribbon and is then looped back 180° to extend past the longitudinal axis of the ribbon. Thereafter this portion of the ribbon is looped back again 180° such that the distal end of the ribbon is sandwiched between the center portion of the loops and is sealed so that the end of the ribbon is hidden and protected from fraying. This tab at the end of the detent ribbon requires no additional strengthening member, with the detent ribbon being easily formed.

Upon removal of the card, the two flaps are separated to form a tentlike structure, with the bottom edges of the tent being prevented from separating further than the length of the detent ribbon.

What is therefore provided is a picture framelike greeting card that has two flaps folded and joined together at the top, prevented from further spreading apart by the tabbed detent ribbon slot structure.

The result is that one has a mailable picture frame greeting card in which the picture can be displayed on a mantle or the like through the use of this folded display card structure.

In summary, a mailable picture frame greeting card includes a folded easel having an apertured front face and an artwork-receiving compartment behind the apertured front face through which a picture or other artwork may be displayed. The card is constructed using a sheet folded to provide a back flap hingedly attached to a front flap and with an easel-maintaining tether, in one embodiment in the form of a tabbed detent ribbon. The untabbed end of the ribbon is fixedly attached to the front flap and the back flap provided with a notch to receive the tabbed end portion of the ribbon, such that the ribbon prevents the two flaps from spreading apart. In one instance the notch has a protective semicircle at the edge of the back flap and a circular hole at the other end. Moreover, a looped and heat-sealed distal ribbon end provides a convenient detent. In one embodiment construction is simplified by providing relatively thick double foam core sticky-backed tape between the front flap and an overlying apertured faceplate or panel, with the thickness of the double sticky-backed tape permitting insertion of a transparent pouch containing a picture or other artwork in the space between the front flap and the panel. Ornamental indicia surrounding the apertured faceplate may be in the form of an apertured frame-shaped panel at the time of manufacture.

### BRIEF DESCRIPTION OF THE DRAWINGS

These and other features of the subject invention will be better understood in connection with a Detailed Description, in conjunction with the Drawings, of which:

FIG. 1 is a diagrammatic illustration of the construction of the subject mailable picture frame greeting card, showing insertion of a photograph into a transparent envelope, which is in turn inserted behind the aperture of the front panel of the card, also showing the ribbon detent structure for preventing the card flaps from moving apart other than by the distance afforded by the length of the tabbed ribbon, also showing the insertion of the flattened card into a mailable envelope;

FIG. 2 is a diagrammatic illustration of the tabbed ribbon structure having one end affixed to the front flap of the card and the other end secured through a notch to the back portion of the back flap of the card;

FIG. 3 is a diagrammatic illustration of the tabbed ribbon, showing the anchored end of the ribbon and the tabbed end showing laterally extending tabs running orthogonal to the plane of the ribbon, with the ribbon positioned within a slot in the back flap of the card;

FIG. 4A is a diagrammatic illustration of a portion of the tabbed ribbon showing a rigid tab extending at right angles to the plane of the ribbon;

FIG. 4B is a diagrammatic illustration of the formation of a ribbon detent by heat sealing a loop ribbon distal end; and,

FIG. 5 is an exploded view of the construction of the subject mailable picture frame greeting card, showing a foldable card stock flaps over which is placed U-shaped, double sticky-backed tape, on top of which is placed an apertured panel, optionally followed by the provision of a decorative apertured front faceplate or panel that gives the look of a frame.

### DETAILED DESCRIPTION

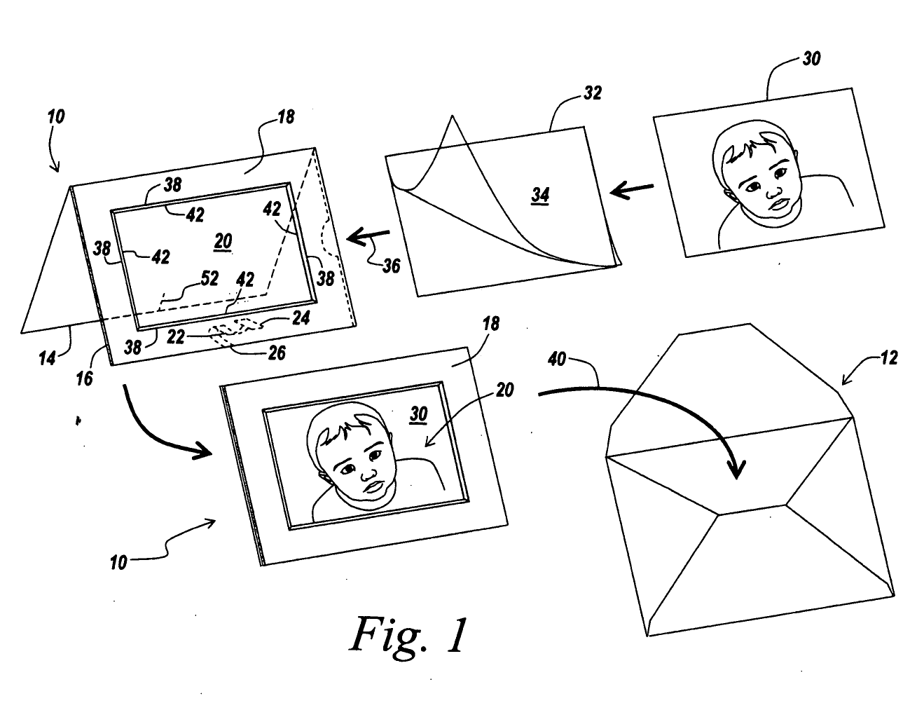

Referring now to FIG. 1, a mailable picture frame greeting card 10 is adapted to be inserted into an envelope 12 for convenient mailing, with the mailable picture frame including a tentlike folded card stock sheet having a back flap 14 and a front flap 16 over which is mounted an apertured panel 18 having an aperture 20 that forms the opening through which artwork, pictures and the like can be viewed.

The mailable picture frame is provided with a ribbon detent 22, illustrated in dotted outline, which has a detent end 24 oriented orthogonal to the ribbon length, with the other end 26 of ribbon 22 being affixed to front fold 16.

A picture or like artwork 30 is adapted to be carried by an envelope 32 having a transparent front face 34, which is inserted as illustrated by arrow 36 between front flap 16 and the edges 38 of panel 18 surrounding aperture 20.

With artwork 30 in envelope 32 and inserted between the front face of the front flap 16 and apertured panel 18, the artwork 30 is exposed through aperture 20. Flaps 14 and 16 are folded in towards each other so that the picture frame greeting card can be inserted as illustrated by arrow 40 into envelope 12. As will be described, the greeting card is made of very low-cost materials, which include card stock, for instance, for the card flaps. Note the front panel may have beveled edges 42 to simulate a beveled matte, with the panel being likewise of relatively inexpensive and lightweight construction.

Envelope 32 may be made of acetate or other transparent material such that the entire cost of the manufacture of the mailable picture frame greeting card is kept to a minimum so as to present to the buyer a greeting card picture frame that is quite easily affordable and one that can be used for multiple mailings as would be the case at holiday time.

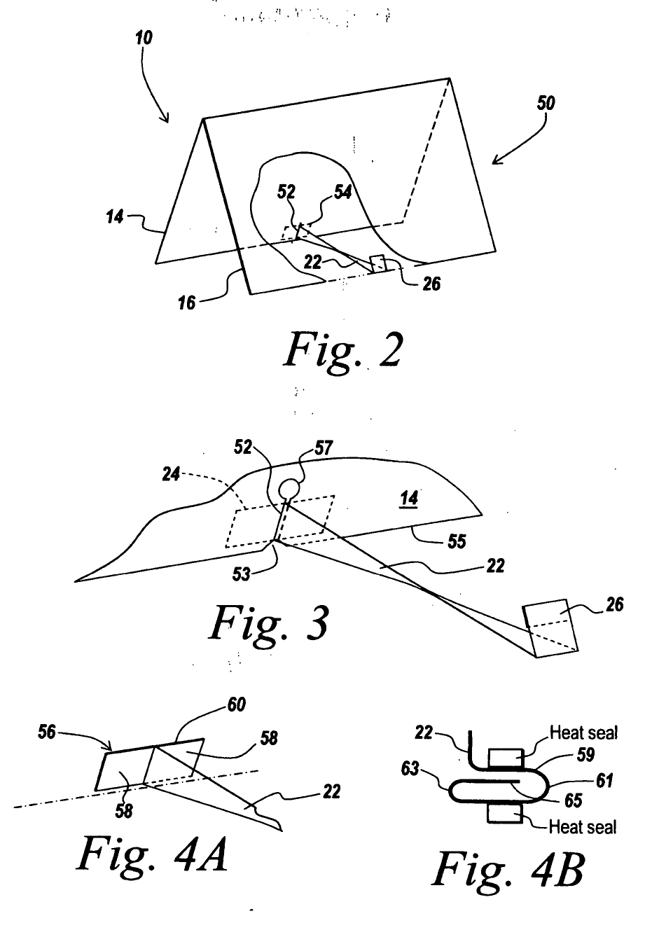

Referring now to FIG. 2, upon receipt and opening of envelope 12, the mailable picture frame 10 is removed from the envelope, with back flap 14 and front flap 16 being moved apart to provide an easel mounting or tentlike structure, here illustrated at 50. As can be seen, the separation of the front and back flaps is controlled by ribbon 22, which has its detent portion 24 coming to rest against the back side of back flap 14 after an intermediate portion of the ribbon is inserted through a notch 52 in the back flap.

The extended ribbon detent co-acts with the back surface of back flap 14 along with the length of ribbon 22 and its anchored distal end 26 to prevent further spread of the front and back flaps, thus to provide an easel-like display that is secure and that can stay in place year round in a self-supported manner.

Referring to FIG. 3, ribbon 22 is shown in detail having its detent end inserted through slot 52 in back flap 14, with the detent portion 24 of ribbon 22 extending behind back flap 12. As can be seen, slot 52 is provided with a semicircular cutout portion 53 at the end of the slot adjacent lower edge 55 of back flap 14 to permit easy insertion of the detent ribbon. Note also that the other end of the slot is opened up to a hole 57 that prevents the slot from tearing and provides a convenient stop for the upper end of the ribbon.

In one embodiment, the detent can be ribbon over cardboard or ribbon over a stiffening structure, or can even be any type of detent, such a ball detent, although a flat detent is preferred so that it does not bulge or protrude out of envelope 12 in FIG. 1.

Referring to FIG. 4A, ribbon 22 in one embodiment is provided with a laterally extending rigid tab 56 in which a ribbon portion 58 surrounds a stiffening board 60 that in general is at right angles to the longitudinal axis of ribbon 22.

Referring to FIG. 4B, in one embodiment the detent portion of ribbon 22 is formed in a convenient folding and heat sealing operation in which a portion 59 of the detent ribbon 22 is moved laterally and folded back on itself as illustrated at 61, moving laterally again to a reverse fold 63 that places the distal end 65 of ribbon 22 within the folded structure. This provides a convenient detent that uses only ribbon and heat-sealing apparatus that uses only the end of the ribbon to form the detent. As mentioned before, sealing the ribbon end behind the folds hides the ribbon end and protects it against fraying.

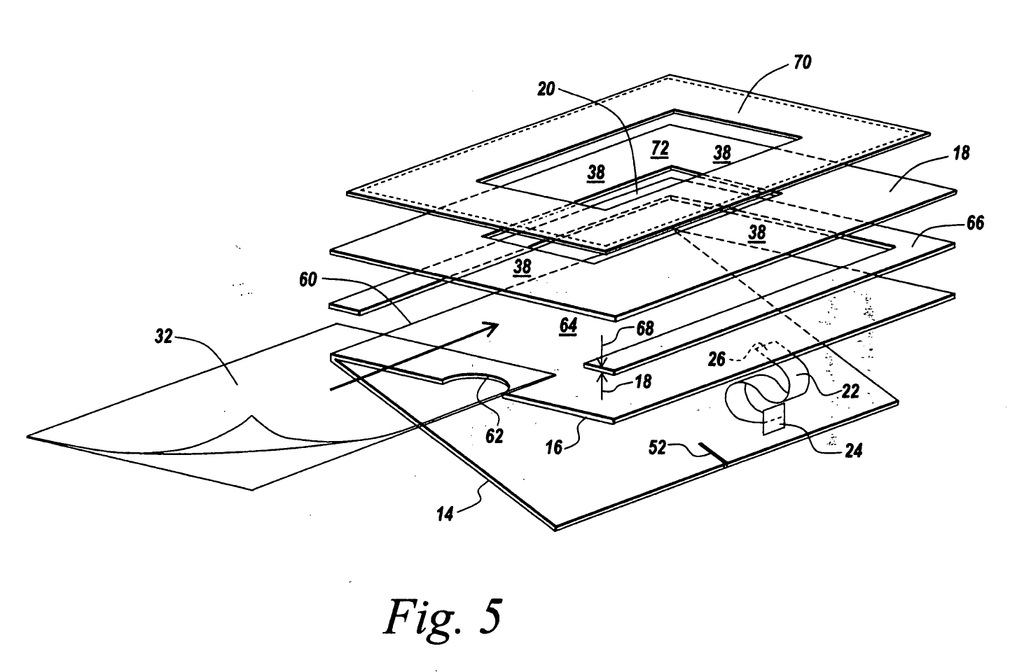

More particularly and referring now to FIG. 5, the construction of one embodiment of the mailable picture frame greeting card is illustrated in which back flap 14 and front flap 16 are shown spaced apart, hinged along a fold line 60 at the top. Front flap 16 is provided with a thumb aperture 62, with front surface 64 of front flap 16 provided with a U-shaped ring of double sticky-backed foam core tape 66 having a thickness illustrated by arrow 68 of 3/16^{th} inch in one embodiment.

In the construction of the mailable picture frame greeting card, this U-shaped double sticky-backed member is affixed to surface 64, after which apertured panel 18 is pressed over the double sticky-backed tape, with the sides 38 of panel 18 spaced from surface 64 by the thickness of the double sticky-backed tape. When sandwiched together, the area within the U-shaped ring 66, the front surface of front flap 16 and the bottom surfaces 38 of panel 18 serve to contain envelope 32 that in one embodiment may be made of acetate.

For decorative purposes, an apertured decorative member 70 in the form of a frame may be affixed to panel 18 so that its aperture 72 is aligned with aperture 20 of panel 18.

It will be appreciated that this assembly procedure is exceedingly low cost, with card stock in one embodiment being used to provide flaps 12 and 16, and with double sticky-backed tape being an exceedingly simple and inexpensive method of providing the pocket or cavity into which envelope 32 is to be inserted between panel 18 and front flap 16.

It will be appreciated that the adhesive on the double sticky-backed tape secures the entire assembly together such that the only other attachable member, namely ribbon 22, is attached at point 26 at the back surface of flap 16 as illustrated.

What is provided is an exceptionally inexpensive yet durable mailable picture frame, which upon receipt can have its back and front flaps separated in easel fashion to provide a display stand for the originally inserted picture, noting that with the detent ribbon in place, the greeting card is self-supported and will not, as is the case with most greeting cards, have its front and back flaps separate one from the other when it is placed on a flat surface, such as a countertop, table, fireplace mantle or the like.

Thus the mailable picture frame greeting card keeps its shape when placed on a flat surface and is yet simple enough in construction and low enough in cost to be able to give the purchaser the option of multiple inexpensive mailings for photographs or artwork.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A mailable picture frame greeting card, comprising in combination:
an envelope for mailing a greeting card;
a picture frame greeting card for insertion in said envelope, said card including a hingedly attached front and back flaps, an apertured front panel on said front flap and spaced from the front surface of said front flap;
a pouch having a transparent face portion inserted into the space between said apertured panel and the face of said front flap such that said transparent face is visible through said apertured panel; and,
artwork located in said pouch viewable through said front panel aperture when said pouch is inserted into said space, whereby a mailable picture frame greeting card is provided with artwork of the user's choosing in a form convenient for mailing.

2. The mailable picture frame greeting card of claim 1, and further including a U-shaped spacer between said apertured panel and said front face of said front flap.

3. The mailable picture frame greeting card of claim 2, wherein said spacer includes double sticky-back tape.

4. The mailable picture frame greeting card of claim 3, wherein said double sticky-backed tape includes a foam center section and opposed adhesive layers sandwiching said center section.

5. The mailable picture frame greeting card of claim 1, and further including a restraint attached between the bottom edges of said two flaps for preventing the spreading apart of said flaps.

6. The mailable picture frame greeting card of claim 5, wherein said restraint includes a ribbon having one end attached to said front flap and having an opposed end carrying a detent and wherein said back flap includes a slot such that when a portion of said ribbon carrying said detent is passed through said slot, said detent engages the back surface of said back flap, the length of said ribbon including said detent end providing a self-supporting greeting card with the separation of said flaps limited by said ribbon.

7. The mailable picture frame greeting card of claim 6, wherein said slot has two ends, one of said ends terminated in a hole and the other of said ends terminated in a semicircle.

8. The mailable picture frame greeting card of claim 7, wherein said ribbon carrying said detent has the detent formed by looping the distal end of said ribbon in itself to form a lateral tab and heat sealing the looped distal portion together such that the distal end of said ribbon is sealed between the loop.

9. A method for providing a mailable picture frame greeting card, comprising:
providing a tentlike greeting card folded along a horizontal line to provide a front and back flap, with the front flap having an apertured panel spaced from the front face of said front flap to provide a cavity therebetween; and,
inserting artwork into the cavity from a side of the card; and,
inserting the card in the envelope, thus to provide a mailable picture frame greeting card.

10. The method of claim 9, wherein the flaps have lower edges and further including limiting the separation of the front and back flaps through the use of a member extending between the lower edges of the flaps so as to provide a self-supporting greeting card when the greeting card is extracted from the envelope and is placed on a surface with the lower edges of the flaps separated and contacting the surface.

11. The method of claim 10, wherein the member includes a ribbon with one end of the ribbon attached to the front flap and the other end carrying a detent end secured to the back flap, whereby when the mailable picture frame greeting card is inserted into the envelope, the ribbon and its detent are contained flat between the flaps.

12. The method of claim 11, wherein the back flap of the greeting card is provided with a slot and wherein the step of providing a member includes slipping a portion of the ribbon into the slot, with the detent contacting the back surface of the back flap at the slot.

13. The method of claim 9, and further including providing an ornamental frame surrounding the apertured panel to establish an ornamental frame-like appearance to the front flap of the picture frame greeting card.

14. A method for displaying a folded greeting card having a front flap and a back flap, comprising the steps of:
providing a detent ribbon anchored at one end to the front flap and at the detent end to the back flap such that the detent ribbon limits the separation of the flaps, whereby the card can be displayed by separating the flaps to the extent of the detent ribbon and placing the separated-flap card on a surface.

15. The method of claim 14, wherein the card includes an apertured front face and a pouch behind the front face for carrying artwork, and further including the step of inserting the artwork in the pouch such that the artwork is viewable through the aperture in the front flap.

16. The method of claim 15, and further including the step of providing that the pouch be transparent at its front face such that the artwork inserted into the pouch is viewable through the apertured front flap.

17. The method of claim 16, wherein said front and back flaps are made from card stock folded along a line.

18. The method of claim 17, and further including the step of providing a cavity in the card in which the pouch can be inserted by providing an apertured panel secured to and spaced from the front flap around three sides thereof, with the open side permitting insertion of the pouch into the cavity.

19. A method of manufacturing a mailable picture frame greeting card, comprising:
providing a sheet of card stock;
folding the card stock in half to provide a front flap and a back flap;
locating a U-shaped region of double sticky-backed foam tape on the front surface of the front flap;
providing an apertured panel over said double sticky-backed foam tape such that the double sticky-backed foam tape spaces the apertured panel from the front face of the front panel; and,
providing an insertable pouch having a transparent front face adapted to be inserted into the cavity provided by the spacing of the apertured panel from the front face of the front panel.

20. The method of claim 19, and further including adhering a decorative frame-like member on top of the apertured panel such that the two apertures are co-aligned.
